(19) United States
(12) Patent Application Publication
(10) Pub. No.: US 2020/0391633 A1
(43) Pub. Date: Dec. 17, 2020

(54) SHOCK-ABSORBING SEAT WITH FLOOR- OR CEILING-MOUNTED DAMPERS

(71) Applicant: RHEINMETALL CHEMPRO GMBH, Bonn (DE)

(72) Inventors: Francois BUDER, Bonn (DE); Michael INDEN, Kerpen (DE); Rene NEULING, Hennef (DE)

(21) Appl. No.: 16/605,085

(22) PCT Filed: Apr. 13, 2018
(86) PCT No.: PCT/EP2018/059603

§ 371 Date: Oct. 14, 2019

(30) Foreign Application Priority Data
Apr. 13, 2017 (DE) 10 2017 108 073.2

(51) Int. Cl. B60N 2/54; B60N 2/015; B60N 2/50

(52) U.S. Cl. CPC B60N 2/546; B60N 2/503; B60N 2/505; B60N 2/015

(57) ABSTRACT

The invention relates to a damping member (1) which has at least two engagement points (2), wherein the damping member (1) comprises at least one spring element (3), the spring elements (3) have an absorption means, the spring elements (3) have a curved shape (4), and the curved shape (4) of the spring elements (3) has a recess (4) which enables the spring elements (3) to be deformed.

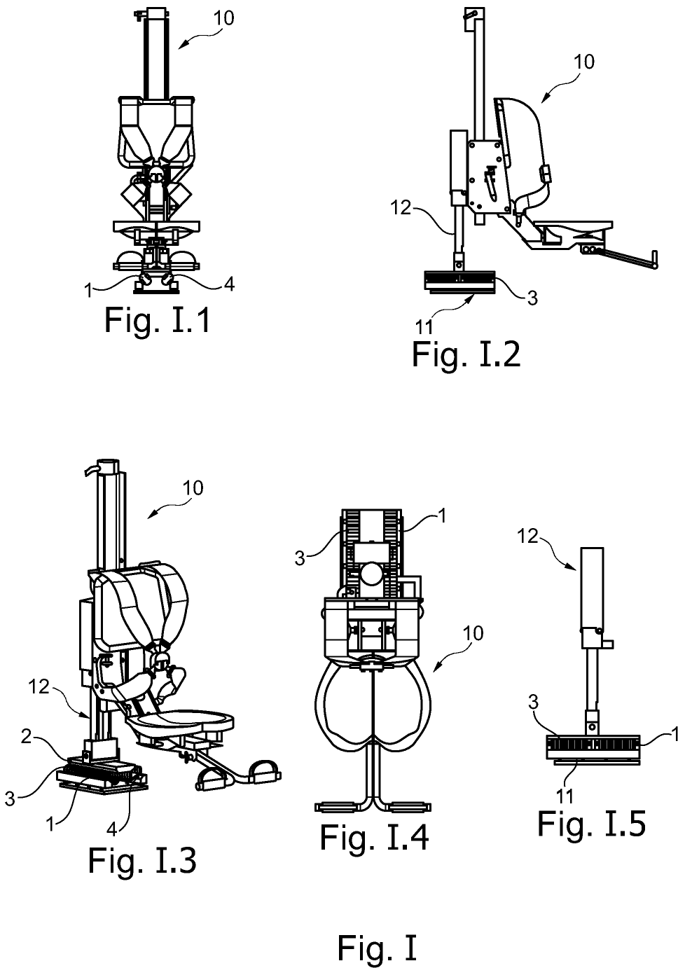

The invention relates to a shock-absorbing damping member and also to a seat for a land vehicle and that has at least one damping member according to the invention.

Seats for land vehicles, in particular for military purposes and that have damping members in order to absorb shocks acting on the vehicle from the outside and therefore provide protection to the occupants sitting on these seats are known. Shocks acting on the vehicle from the outside are generally impacts from explosive materials, as are used for example in mines over which the vehicle drives.

DE 10 2008 053 152 discloses a deformation element for protecting a device, in particular a footrest plate in an, in particular, military vehicle, wherein the deformation element is substantially U-shaped.

The object of the invention is to provide a damping member that renders possible shock absorption with reasonable expenditure on manufacture. Another object of the invention is to provide a seat for a vehicle that protects the person using it from external impacts.

The invention proposes a damping member that has at least two attachment points in order to introduce forces, which occur in a pulsed manner, into the damping member.

According to the invention, the damping member consists of at least one spring element.

The damping member further has fastening elements by which the damping member can be fastened. The fastening elements are preferably arranged at the attachment points, so that the action of force on the damping member can take place through the fastening elements.

The damping member according to the invention further has a force absorber that is capable of absorbing introduced forces and in this way can damp the actions of force that occur in a pulsed manner.

A force absorber of this kind can be a compressible substance or an elastic substance that returns to its initial state after action of force.

To this end, the force absorber can be integrated into the spring elements or the force absorber constitutes the material of the spring elements. A plurality of spring elements are preferably provided for one damping member.

The spring elements are configured such that they can absorb an action of force in order to damp forces that occur in a pulsed manner. To this end, the spring elements are of curved configuration. This curved shape first has the advantage that the spring elements are more stable than in the case of straight shapes since curved shapes can withstand greater forces than straight shapes. Second, a recess through which the spring elements can be deformed in the event of action of force can, however, be provided in the case of a curved shape. The spring elements are initially of elastic configuration owing to the force absorber and their shaping. This means that they withstand a certain action of force without deformation. However, when this action of force becomes too great, the sides or ends of the spring elements can move toward one another at the recesses owing to deformation and thereby absorb and damp further forces.

Therefore, in a particular embodiment, a C-shape has proven advantageous for the spring elements.

The damping members are designed such that they can be used in a vehicle in order to cushion a vehicle seat against impact forces that are exerted on the seat. To this end, it is proposed to arrange at least one damping member according to the invention on the seat of the vehicle.

The seat can be damped by at least one damping member being arranged between the seat and the vehicle chassis.

Similarly, the seat can also be arranged in a manner suspended from the ceiling of the passenger compartment. In this case, at least one damping member is provided between the suspension arrangement and the ceiling.

In order to adapt the damping property to a special seat or use, the invention proposes using a plurality of spring elements in one damping element.

To this end, a plurality of spring elements can be arranged parallel to one another. They force to be absorbed by the damping member is increased owing to the arrangement of a plurality of spring elements.

An arrangement of a plurality of spring elements next to one another is also conceivable. The combination of a plurality of spring elements parallel to one another and next to one another is recommended. For example, a plurality of rows of spring elements on one damping member could be used for this purpose.

Similarly, a plurality of spring elements one on the other can be used. This increases the travel of the deformation and a higher elasticity can be achieved.

The damping properties, such as elasticity and deformation travel, can be adapted to a specific purpose owing to the combination of the above-described arrangement options for the spring elements in one damping member.

One advantage of the present invention is that the seat can be arranged in a vertically adjustable manner. The damping members according to the invention do not impede this vertical adjustment.

For vertical adjustment purposes, the seat comprises a pillar to which it is connected in an articulated manner. The seat can then be vertically adjusted on the pillar using suitable means. The damping members are then provided at the fastening of the pillar, either on the chassis of the vehicle or on the ceiling of the passenger compartment.

In both cases, the damping member according to the invention is between the fastening of the seat and the chassis or the ceiling. The damping member can be fitted between the seat and the chassis/ceiling by the fastening elements.

For the fastening element of the damping member, the spring element can also be designed as a fastening element. The seat can be arranged, in particular arranged in a vertically adjustable manner, on said fastening element where the fastening element can have a plurality of spring elements that can each be of C-shaped design and are connected to the chassis or the ceiling of the vehicle.

When C-shaped spring elements are used, the plurality of C-shaped spring elements can be deformed as a result of an impact on the vehicle from the outside and therefore considerably reduce the impact energy exerted on the seat, so that the person sitting on the seat is effectively protected against this external impact as a result.

If a plurality of C-shaped spring elements that are one behind the other are used, these are designed with one of their turning points as a fastening element on which the seat is arranged. By their other turning point, the spring elements are fastened to the chassis of the vehicle, or to corresponding carrier elements. With particular preference, not only are a plurality of C-shaped spring elements arranged one behind the other in series, but rather two or even more than two rows of spring elements of this kind are parallel to one another, as a result of which the shock-absorbing action of the entire damping member can be adjusted.

Further features of the present invention are shown in the figures, in which:

FIG. I shows a seat according to the invention having damping elements and a pillar for vertically adjusting the seat;

FIG. I.1 is a front view of the seat;

FIG. I.2 is a side view of the seat;

FIG. I.3 is a perspective view of the seat;

FIG. I.4 is a top view of the seat;

FIG. I.5: shows a damping element according to the; invention on the pillar.

FIG. I illustrates an embodiment of a damping member 1 in which the seat 10 is connected to a chassis 11 of an unillustrated vehicle by this damping member 1.

It can be seen that the seat 10 is for example vertically adjustable on a pillar 12 that ca form a constituent part of the damping member 1 or be on a portion of the damping member 1.

Toward the floor there are a plurality of spring elements 3 of curved shape 4, for example C-shaped, positioned at least in one row, here in two rows parallel to one another. In this case, the spring elements 3 together form the damping member 1.

There is no, or no appreciable, deformation of the C-shaped spring elements 3 during normal loading of the seat 10. These C-shaped spring elements can deform and thereby absorb the impact energy only in the event of an impact on the vehicle from the outside. When this takes place the C-shaped spring elements 3 deform and in the process the free ends of the large C are able to move toward one another. In this case, the impact energy is transmitted to the damping members through attachment points 2.

The present invention is not restricted to the above-described features. Rather, further refinements are possible. Therefore, the spring elements can be arranged not only on the suspension arrangement or on the pillar of the seat, but rather also in the pillar itself. The vertically adjustable seat is specially damped as a result. Therefore, an individual degree of damping can be set by combining damping members in the pillar and the suspension arrangement of the seat.

LIST OF REFERENCE SIGNS

| | |
|---|---|
| 1 | Damping member |
| 2 | Attachment point |
| 3 | Spring element |
| 4 | Curved shape |
| 10 | Seat |
| 11 | Chassis |
| 12 | Pillar |

1. In a damping member that has at least two attachment points, the improvement wherein:
the damping member comprises a plurality spring elements,
the spring elements each have a force absorber,
the spring elements each have a curved shape, and
the curved shape of each of the spring elements forms a recess that renders possible deformation of the spring elements.

2. The damping member according to claim 1, wherein the force absorber is inside the spring elements.

3. The damping member according to claim 1, wherein the force absorber is embodied as material of the spring elements.

4. The damping member according to claim 1, wherein at least one spring element is C-shaped.

5. The damping member according to claim 1, further comprising:
fastening elements are at the attachment points.

6. The damping member according to claim 5, wherein the fastening elements are on each spring element.

7. The damping member according to claim 1, wherein the force absorber consists of an elastically deformable material.

8. The damping member according to claim 1, wherein the spring elements are parallel to one another.

9. The damping member according to claim 1, wherein the spring elements are next to one another.

10. The damping member according to claim 1, wherein the spring elements are one on the other.

11. A seat for a land vehicle, wherein the seat comprises at least one damping member according to claim 1.

12. The seat according to claim 11, wherein the damping member is between the seat and a chassis of the land vehicle.

13. The seat according to claim 11, wherein the damping member is between the seat and the ceiling of the land vehicle.

14. The seat according to one claim 11, wherein the seat comprises a pillar on which the seat can be vertically adjusted.
